(19) United States
(12) Patent Application Publication
(10) Pub. No.: US 2026/0295669 A1
(43) Pub. Date: Oct. 1, 2026

(54) METHODS FOR FABRICATING ARTICLES HAVING DIFFERENT MATERIALS THROUGH HOT ISOSTATIC PRESSING AND ADDITIVE MANUFACTURING, METHODS FOR FABRICATING NUCLEAR FUEL ASSEMBLIES THROUGH HOT ISOSTATIC PRESSING AND ADDITIVE MANUFACTURING, AND RELATED NUCLEAR FUEL ASSEMBLIES

(71) Applicant: Battelle Energy Alliance, LLC, Idaho Falls, ID (US)

(72) Inventors: Joshua N. Zelina, Idaho Falls, ID (US); Nicolas E. Woolstenhulme, Idaho Falls, ID (US)

(21) Appl. No.: 19/630,199

(22) Filed: Mar. 26, 2026

Related U.S. Application Data
(60) Provisional application No. 63/778,231, filed on Mar. 26, 2025.

(51) Int. Cl. B22F 7/06; B22F 10/64; B33Y 40/20; B33Y 80/00; G21C 3/08

(52) U.S. Cl. CPC B22F 7/06; B22F 10/64; B33Y 40/20; B33Y 80/00; G21C 3/08; B22F 2998/10

(57) ABSTRACT

A method of fabricating a nuclear fuel assembly includes forming, via additive manufacturing, a cladding that exhibits a first density less than a theoretical maximum density of a material of the cladding, where the cladding defines an interior volume. The method further includes introducing a nuclear fuel into the interior volume of the cladding. The method further includes densifying, via hot isostatic pressing, the cladding and the nuclear fuel in the interior volume, such that the cladding exhibits a second density greater than the first density. Additional methods and nuclear fuel assemblies are disclosed.

### CROSS-REFERENCE TO RELATED APPLICATION

This application claims the benefit of and priority to U.S. Provisional Patent Application No. 63/778,231, filed Mar. 26, 2025, the contents of which are incorporated herein by reference in their entirety.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to fabrication of articles utilizing additive manufacturing. More specifically, this disclosure relates to the fabrication of articles having complex geometries through additive manufacturing and hot isostatic pressing.

### BACKGROUND

Additive manufacturing, often referred to as 3D printing, is a process of creating three-dimensional articles by adding material in layers atop one another. The layers may be added by depositing material, hardening material, melting a powder, binding a powder, or the like. The development of additive manufacturing has facilitated the creation of parts having complex geometries that are difficult or impossible to build with conventional manufacturing processes.

For example, conventional heat exchangers formed by conventional manufacturing processes include rods running through a tank, parallel plates, or the like. However, more efficient heat transfer in a heat exchanger may be achieved using more complex geometries involving various internal curvatures which are difficult or impossible to form via conventional manufacturing processes. Such geometries may include triply periodic minimal surfaces among other geometries.

### BRIEF SUMMARY

According to aspects of the disclosure, a method is provided for fabricating an article comprising different materials. The method includes forming, via additive manufacturing, a part from a first material, where the part exhibits a first density and has surfaces defining an interior volume. The method further includes introducing a second material into the interior volume, where the second material exhibits a second density. The method further includes processing, via hot isostatic pressing, the part comprising the first material and the second material to form the article, such that the first material exhibits a third density greater than the first density and the second material within the part exhibits a fourth density greater than the second density.

According to other aspects of the disclosure, a method is provided for fabricating a nuclear fuel assembly. The method includes forming, via additive manufacturing, a cladding that exhibits a first density less than a theoretical maximum density of a material of the cladding, where the cladding defines an interior volume. The method further includes introducing a nuclear fuel into the interior volume of the cladding. The method further includes densifying, via hot isostatic pressing, the cladding and the nuclear fuel in the interior volume, such that the cladding exhibits a second density greater than the first density.

According to other aspects of the disclosure, a nuclear fuel assembly is provided. The nuclear fuel assembly includes a lattice cladding formed of a cladding material, nuclear fuel disposed within the lattice cladding, and a transition manifold coupled to an end region of the lattice cladding. The lattice cladding defines a nuclear fuel-receiving interior volume and coolant passageways that are separated from the nuclear fuel-receiving interior volume by walls of the lattice cladding. The transition manifold includes a port and branching passageways between the port and openings at a boundary of the lattice cladding. The lattice cladding includes a complex geometry defining one or more of tortuous passageways or intertwined internal passageways. The lattice cladding exhibits a density of at least about 95% of a theoretical maximum density of the cladding material, and the nuclear fuel exhibits a density of at least about 70% of a theoretical maximum density of the nuclear fuel.

### BRIEF DESCRIPTION OF THE SEVERAL VIEWS OF THE DRAWINGS

For a detailed understanding of the disclosure, reference should be made to the following detailed description, taken in conjunction with the accompanying drawings, in which like elements have generally been designated with like numerals.

FIG. 1 shows a flow chart of a method of fabricating a nuclear fuel assembly in accordance with some embodiments.

FIG. 2 shows a three-dimensional section of a nuclear fuel assembly fabricated in accordance with some embodiments.

FIG. 3 shows a three-dimensional section of a lattice cladding for a nuclear fuel assembly fabricated in accordance with some embodiments.

FIG. 4 shows an exemplary lattice cladding with an inlet manifold and an outlet manifold in accordance with some embodiments.

FIG. 5A shows an exemplary lattice cladding of a nuclear fuel assembly with an attached manifold, FIG. 5B shows a section view of the nuclear fuel assembly with the attached manifold of FIG. 5A, and FIG. 5C shows the nuclear fuel assembly of FIG. 5A with a fission gas reservoir attached thereto, in accordance with some embodiments.

### DETAILED DESCRIPTION

The illustrations presented herein are not actual views of any article formed by additive manufacturing and hot isostatic pressing (HIP), or any component thereof, but are merely idealized representations, which are employed to describe embodiments of the invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any article formed by additive manufacturing and hot isostatic pressing when utilized in a conventional manner. Furthermore, these terms may refer to an orientation of elements of any article formed by additive manufacturing and hot isostatic pressing as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

Additive manufacturing processes may be utilized to form articles having complex geometries that are difficult or impossible to form utilizing conventional manufacturing methods. Additive manufacturing processes according to embodiments of the disclosure may be utilized to form the articles having complex geometries such as heat exchangers.

A nuclear reactor is, in some respects, similar to a heat exchanger. A nuclear reactor is built to safely contain nuclear fuel and fission products while efficiently transferring heat from the nuclear fuel. Due to a nuclear reactor's similarities with a heat exchanger, components of the nuclear reactor may also benefit from incorporating more complex geometries to increase the efficiency of the nuclear reactor.

To fabricate a nuclear reactor, cladding is formed with the purpose of containing the nuclear fuel therein and to facilitate heat transfer. The nuclear fuel is housed inside of the cladding. The cladding may function as a so-called “shell” for containing the nuclear fuel. Two general approaches may be used to form the nuclear reactor using additive manufacturing: single material additive manufacturing and multi-material additive manufacturing.

With single material additive manufacturing, the cladding is formed by additive manufacturing, and then the formed cladding is filled with the nuclear fuel. However, in order to fill the cladding, the nuclear fuel is dispensed in a powder to form a packed powder within the cladding. This packed powder results in a low-density fuel in the reactor which may decrease reactor efficiency, negating gains obtained by the geometry of the cladding formed by additive manufacturing.

In order to densify the nuclear fuel in the cladding, the cladding and the added fuel may undergo further processing. For example, hot isostatic pressing may be utilized to densify the fuel in the cladding. This, however, may result in deformation of the cladding as the volume of the fuel decreases during densification as compared to the volume of the cladding due to the cladding's higher starting density. The resulting cladding may, thus, have one or more parts that become bowed, buckled, or otherwise deformed, making it difficult to achieve fuel geometries that are desired for use in reactors, and/or which may decrease the efficiency of the reactor and, in some instances, cause damage to the reactor.

With multi-material additive manufacturing, the cladding and the fuel are printed simultaneously, layer by layer. While this allows for single step fabrication, there are several drawbacks to this method. First, multi material additive manufacturing (e.g., multi-material metal powder bed additive manufacturing) utilizes specialized powder feedstock in order to print two or more materials at the same time. It also has a high percentage of material waste which, especially for nuclear applications, may be hazardous and may increase costs substantially. Furthermore, multi-material metal powder bed additive manufacturing may result in contamination where fuel particles may end up in the cladding, which increases radiological hazards. Currently, multi-material metal powder bed additive manufacturing has a relatively high cost and would be limited to metal fuel systems.

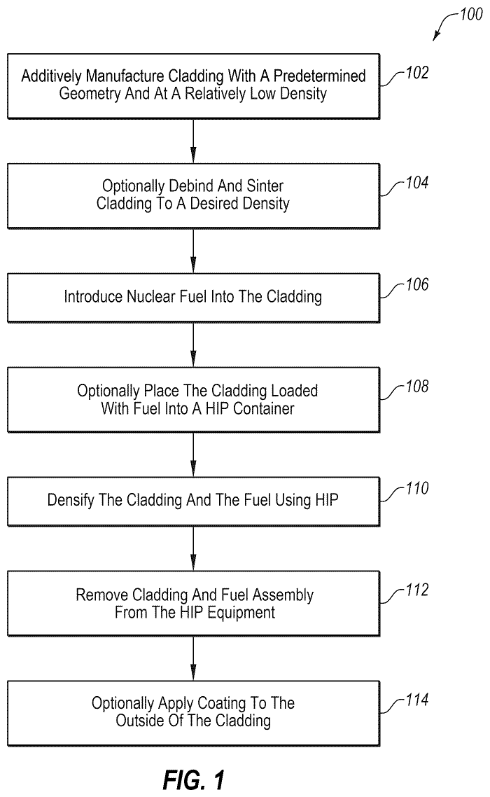

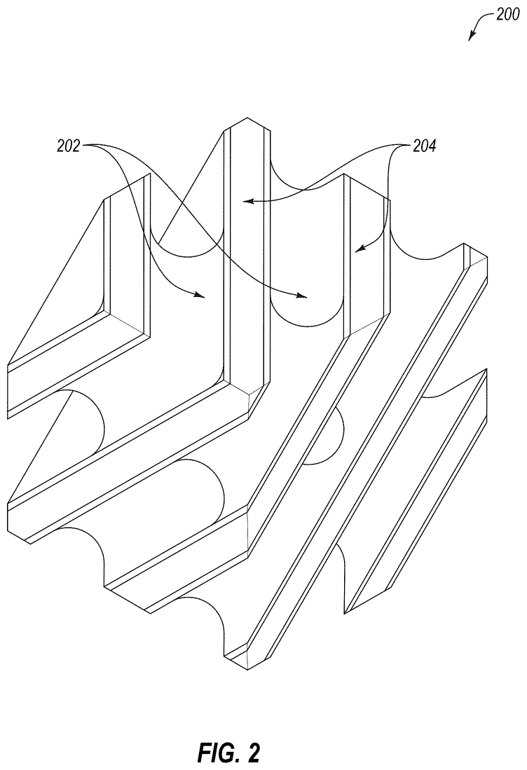

Accordingly, disclosed herein are methods of fabricating articles through additive manufacturing and hot isostatic pressing. The article may be formed to a near net shape or a final shape. The methods may facilitate the fabrication of a nuclear reactor including an article (e.g., a nuclear fuel assembly) having both complex geometries and densified fuel within the complex geometries. FIG. 1 shows a flowchart illustrating a method 100 of fabricating articles through additive manufacturing and hot isostatic pressing. In FIG. 1, the method 100 includes act 102 where cladding of an article, such as of a nuclear reactor, is formed via additive manufacturing having a predetermined geometry and at a relatively low density.

A variety of additive manufacturing processes may be utilized in act 102. For example, the cladding may be formed via a powder-bed additive manufacturing process. Examples include selective laser melting/laser powder bed fusion (LPBF), electron-beam melting, and other powder-bed fusion techniques. As another example, the cladding may be formed via a material-extrusion additive manufacturing process. One non-limiting example is filament-based deposition modeling (FDM) using a bound-metal filament that includes metal particles dispersed in a polymer binder. In another example, the cladding may be formed via binder jetting. In binder jetting, a powder layer may be formed and a binder may be selectively deposited to adhere the powder. Other additive manufacturing techniques suitable for forming a three-dimensional cladding having the predetermined geometry may also be used.

In filament-based and binder-jet processes, the cladding may include a polymeric binder after printing. The polymeric binder may later be removed, for example, via a debinding operation. In powder-bed fusion embodiments, the cladding may be formed without a polymer binder. The selected additive manufacturing approach may provide a desired balance among dimensional fidelity, surface finish, and build rate. In some embodiments, the approach also addresses binder-related volatilization considerations during subsequent thermal processing.

The cladding is formed having a predetermined geometry. The predetermined geometry may be a complex geometry that would be difficult or impossible to fabricate with conventional fabrication methods. For example, the complex geometry may comprise a triply periodic minimal surface (TPMS) lattice (sometimes referred to herein as a triply periodic minimal (TPM) surface) defined by an implicit surface equation and periodically repeated in three dimensions. Non-limiting examples of TPMS lattices include a diamond-type TPM surface, a gyroid TPM surface, and/or other TPMS families and variants thereof (e.g., scaled, rotated, truncated, graded, and/or offset surfaces). Such geometries may define tortuous and/or intertwined internal passageways, including re-entrant curvature, undercut features, and/or interconnected cavities in which line-of-sight and direct tool access to interior regions is obscured. Such internal, interconnected features may be difficult or impossible to fabricate as a unitary monolithic component using conventional subtractive manufacturing techniques (e.g., drilling, milling, and turning), which generally rely on direct line-of-sight and tool access, and which may otherwise require splitting the component into multiple pieces and rejoining (e.g., welding, brazing, or diffusion bonding) to approximate the desired geometries. The predetermined geometry may incorporate internal volumes into which a second material (e.g., nuclear fuel) may be added as discussed in more detail below.

A material of the cladding is selected depending on the intended use of the article. If, for instance, the cladding is to be used in a nuclear reactor or other extreme environment, the material of the cladding may be resistant to high temperature, radiation, and corrosion conditions. The material selected for use in the cladding may be a metal, a ceramic, or a ceramic-metal material. For example, steel alloys, refractory alloys (e.g., zirconium alloys), nickel-based alloys, or the like may be used. The material may be available in powder form or other form suitable for additive manufacturing.

The additive manufacturing process used to form the cladding in act 102 results in the material of the cladding being fabricated at an initial, relatively low density. For example, the initial density of the cladding formed in act 102 may be greater than or equal to about 50% of a theoretical maximum density for the material used to form the cladding. In some examples, the density of the cladding following act 102 may be greater than or equal to about 50% and less than or equal to about 90% of the theoretical maximum density for the material used to form the cladding.

In some embodiments, the initial density (or “green” density) of the additively manufactured cladding is selectively controlled by one or more process parameters of the additive manufacturing technique. For example, in filament-based extrusion processes (e.g., bound-metal filament deposition), the initial density may be adjusted by selecting a bead spacing, an infill percentage/pattern, a toolpath strategy, a bead overlap, a layer height, and/or a binder fraction of the feedstock. In binder-jetting processes, the initial density may be adjusted by selecting a powder packing condition (e.g., powder characteristics and packing during recoating), a layer thickness, a recoating strategy, and/or a binder saturation (e.g., binder content and/or binder deposition pattern). In powder-bed fusion processes (e.g., laser powder bed fusion), the initial density may be adjusted by selecting a beam power, a scan speed, a hatch spacing, a layer thickness, and/or a scan strategy (e.g., an outline-only strategy and/or reduced volumetric energy density). Process parameters may be selected to intentionally introduce lack-of-fusion porosity and/or to avoid fully consolidating one or more regions, thereby yielding the initial density described above.

Once the cladding has been initially formed via additive manufacturing, the cladding may optionally undergo a debinding and sintering process in act 104. If the additive manufacturing process employs a polymeric binder (e.g., bound-metal filament deposition and/or binder jetting), the cladding may be subjected to a debinding operation to remove at least a portion of the binder prior to densification. Debinding may be performed in a dedicated furnace under vacuum and/or an inert atmosphere (e.g., argon). Debinding may include heating or sintering according to a temperature schedule selected to volatilize and/or decompose the binder while limiting deformation of the cladding geometry. For example, the temperature may be increased in one or more controlled manners with one or more dwell periods to promote binder removal and outgassing, followed by cooling prior to subsequent acts.

The optional debinding and sintering may also be utilized to further densify the cladding to a predetermined intermediate density such as a density that is greater than the initial density after additive manufacturing following act 102 but less than a final density of the finished article. The intermediate density of the cladding may be greater than or equal to about 50% and less than or equal to about 90% of the theoretical maximum density for the material used to form the cladding. The intermediate density may correspond with a density of a nuclear fuel to be added to and held within the cladding, as explained below.

In act 106, a nuclear fuel may be introduced into the cladding. For example, particles of nuclear fuel in the form of a powder may be poured into the cladding to fill the interior volume of the cladding. The powder particles may be packed into the cladding as a packed powder. The packed powder of the nuclear fuel may exhibit a density that is less than a theoretical maximum density of the nuclear fuel. The density of the packed powder may be equal to or greater than about 30% of the theoretical maximum density of the nuclear fuel. In some embodiments, the density of the packed powder may be equal to or greater than about 40%, 50%, or 70% of the theoretical maximum density of the nuclear fuel. In some embodiments, the nuclear fuel may be introduced into the cladding in other states of matter, such as being poured into the cladding in a liquid state. The nuclear fuel may be a metal, a ceramic, or a combination thereof. By way of example only, the nuclear fuel may be uranium dioxide or a uranium zirconium alloy. Vibrating and tailoring the particle size distribution of the nuclear fuel may be used to achieve an initial packed powder density.

For example, incorporation of the nuclear fuel (e.g., fuel loading) in act 106 may include a vibration packing operation to increase the packed density of a particulate fuel within the cladding. After introducing a quantity of fuel particles into the cladding, the cladding may be subjected to tapping and/or mechanical vibration to settle the particles. The vibration may be applied using, for example, a vibrating table, a shaker, or the like. In some embodiments, the vibration frequency and/or amplitude is selected to promote particle rearrangement and reduce void volume. In some embodiments, ultrasonic vibration is additionally or alternatively applied to the cladding to help initially settle the particulate fuel within the cladding.

In some embodiments, fuel loading in act 106 is performed in a batch-wise manner. For example, a first batch of fuel particles may be introduced, the cladding may be vibrated to settle the fuel particles of the first batch, and one or more additional batches of fuel particles may then be sequentially introduced with intervening vibration acts. This approach may be useful for elongated cladding structures and/or cladding structures having tortuous internal passageways.

In some embodiments, incorporation of the nuclear fuel in act 106 includes a fluidization-assisted fill. For example, a gas may be flowed through the cladding (e.g., through the lattice passageways) during introduction of the fuel particles to promote movement and distribution of the particles. The gas may be an inert gas such as argon, nitrogen, helium, or combinations thereof. The flow rate may be selected to provide fluidization or partial fluidization of the fuel particles during filling.

In some embodiments, the nuclear fuel introduced into and packed within the cladding has an initial density of at least about 30%, of at least about 40%, or of at least about 50% of theoretical density. In some embodiments, the initial density is at least about 60% of theoretical density. In some embodiments, the initial density is about 70% of theoretical density (e.g., from about 40% to about 75% of theoretical density), prior to subsequent densification operations described herein.

In some embodiments, the nuclear fuel is provided as particulates (e.g., powder) having a selected particle size distribution to promote packing within the cladding. For example, the particle size distribution may be multi-modal, including a blend of relatively larger particles and relatively smaller particles, such that the smaller particles occupy interstitial spaces between the larger particles. Stated differently, the particulate nuclear fuel may include a combination of “coarse and fine” particles (e.g., analogous to “sand and gravel”) to increase the achievable packed density prior to subsequent densification.

In some embodiments, the particulate fuel has a selected particle morphology to promote packing and/or flow during filling. For example, the particulate fuel may include particles that are generally spherical (e.g., to improve flowability through tortuous passageways), particles that are generally irregular (e.g., to increase frictional interlock), and/or combinations thereof. In some embodiments, the particulate fuel includes a combination of morphologies and/or surface textures selected to reduce bridging (e.g., particles contacting one another to form a “bridge” leaving a void or under-filled zone therebelow) during fill while increasing packed density. The above examples are not intended to be limiting, and the fuel loaded into the cladding in act 106 may be any generally available powder feedstock. The fuel loading in act 106 may result in near zero feedstock waste of the powder feedstock.

In some embodiments, the particulate fuel further includes one or more process additives selected to influence densification behavior during subsequent consolidation. For example, in ceramic fuel embodiments (e.g., UO₂), the particulate fuel may include one or more sintering aids to promote attainment of higher density during a sintering and/or hot isostatic pressing operation. Non-limiting examples of the sintering aids include chromium oxide and aluminum oxide.

In addition or as an alternative, the particulate fuel may include one or more additives selected for reactor operation. For example, in certain reactor applications, the particulate fuel may include neutron absorbing particles and/or burnable poison particles combined with the fuel particles. Non-limiting examples include boron carbide and gadolinium oxide. Such additives may be present in an amount selected to provide desired neutronic characteristics during operation of the nuclear reactor.

Act 106 may further include process monitoring to assess loading quality of the nuclear fuel and to verify that the nuclear fuel has been distributed and packed to a desired extent within the cladding. For example, when vibration packing fuel into a cladding having a tortuous internal geometry and/or an elongated axial length, fuel loading may be performed in increments (e.g., batch-wise fills along the axial length). After introducing each increment, a non-destructive evaluation (NDE) technique may be used to assess one or more characteristics including a fill level, a local packed density, and/or a degree of settling for the increment. In some embodiments, the NDE technique comprises radiographic inspection, such as using an X-ray source to transmit a beam through a region of the cladding and acquiring data on an opposing side indicative of the amount and/or distribution of nuclear fuel within that region.

The process monitoring may be used for closed-loop control of the fuel loading operation. For example, based on the monitored indication of packed density and/or settling for a given increment, one or more vibration packing parameters may be adjusted, such as vibration time, vibration frequency, vibration amplitude, and/or the number of vibration cycles. In some embodiments, the process monitoring supports automated decision-making (e.g., “shake longer” where a region is under-packed) to achieve the desired packed density. In some embodiments, radiographic inspection relies on the relatively higher attenuation of the radiographic beam by a uranium-bearing fuel to distinguish fuel-filled regions from unfilled regions.

As a result of act 106, the cladding formed via additive manufacturing and the nuclear fuel in the cladding each have a density that is less than the theoretical maximum density of the respective materials. The cladding and the nuclear fuel may undergo further processing acts, as discussed below, to simultaneously densify both the cladding and the nuclear fuel. As mentioned above, the initial density of the cladding formed in act 102 and, optionally, act 104 is chosen to correspond with the initial density of the nuclear fuel after the fuel is introduced into the cladding in act 106. In some embodiments, the initial density of the cladding corresponding with the initial density of the nuclear fuel may be that the initial density of the cladding is chosen to be substantially similar to the initial density of the nuclear fuel. In other embodiments, the initial density of the cladding corresponding with the initial density of the nuclear fuel may be that the initial density of the cladding is chosen such that after simultaneously processing the cladding and the nuclear fuel, as will be described below, both the cladding and the nuclear fuel reach a respective final desired density. In some embodiments, the initial density of the cladding, the initial density of the nuclear fuel after act 106, and subsequent processing conditions are selected to reduce differential shrinkage, reduce distortion of the cladding geometry, and promote attainment of the respective final desired densities.

The final desired density of the cladding may be selected to provide a substantially hermetic barrier and structural integrity. For example, the final desired density of the cladding may be at least about 80% of the theoretical maximum density of the cladding. In some embodiments, the final desired density of the cladding may be at least about 95% of the theoretical maximum density of the cladding. In some embodiments, the final desired density of the cladding may approach the theoretical maximum density (e.g., about 99% or more).

The final desired density of the nuclear fuel may be selected based on the nuclear fuel form. In some embodiments, the final desired density of the nuclear fuel is at least about 60% of the theoretical maximum density. In ceramic fuel embodiments (e.g., UO₂), the final desired density of the nuclear fuel may be in the low-to-high 90% range of the theoretical maximum density (e.g., about 90% or more, such as about 93% to about 97%, or higher). In metallic fuel embodiments (e.g., metallic alloy fuels), the final desired density of the nuclear fuel may be deliberately less than full density, such as from about 65% to about 95% of the theoretical maximum density of the nuclear fuel, to retain a controlled amount of free volume and/or porosity (e.g., for fission gas accommodation and/or swelling management).

In some embodiments, the final desired densities of the cladding and the nuclear fuel are substantially the same as a percentage of the theoretical maximum density of each of the cladding and the nuclear fuel, respectively. In other embodiments, the final desired densities of the cladding and the nuclear fuel are different as a percentage of the theoretical maximum density of each of the cladding and the nuclear fuel, respectively.

In act 108, the cladding that is loaded with nuclear fuel may optionally be placed into a hot isostatic pressing container. Act 108 may be omitted, such as when the cladding is sufficiently hermetic prior to hot isostatic pressing. When act 108 is omitted, the cladding that is loaded with nuclear fuel may be densified via hot isostatic pressing without placement into a hot isostatic pressing container. When the hot isostatic pressing container is used, the hot isostatic pressing container may comprise a sealable metal enclosure (e.g., a welded metal canister) configured to be evacuated and sealed prior to hot isostatic pressing. The container may include an evacuation tube, stem, or port coupled to an interior volume of the container.

A support material (also referred to as a filler material) may be arranged around and/or within portions of the cladding to transmit pressure and heat during HIP processing and to support the cladding geometry. In some embodiments, the support material occupies regions that are configured to become a coolant domain (e.g., coolant passageways) after processing and is selected to be removable after HIP (e.g., by mechanical removal and/or chemical removal). In some embodiments, the support material is selected to be substantially non-reactive with the cladding and the nuclear fuel under HIP operating conditions, and to be not prone to sintering or sticking together at the selected HIP temperature and pressure. Non-limiting examples of support materials include zircon-based ceramics and other oxide ceramics, such as magnesium oxide.

In some embodiments, one or more getter materials are positioned within the container to scavenge residual gases during evacuation, bakeout, and/or HIP processing. For example, an oxygen getter and/or a hydrogen getter may be included within the container, such as by distributing the getter material in or around the support material. The getter material may comprise, for example, a refractory metal having an affinity for absorbing one or more gaseous species.

If the cladding is placed into the container, after loading the cladding and the support material into the container, the interior volume may be evacuated (e.g., vacuum drawdown) to remove air, moisture, and/or other gases. In some embodiments, the container is subjected to a thermal conditioning and/or degassing process while under vacuum (and/or under an inert atmosphere) to remove residual volatiles. For example, the thermal conditioning and/or degassing process may remove binder-related volatiles if the cladding is formed using a binder-containing additive manufacturing process, and/or may remove adsorbed moisture or other contaminants.

After evacuation and/or thermal conditioning, the container may be sealed (e.g., by crimping and welding, pinch-off and welding, or otherwise sealing the evacuation tube/port) prior to the HIP process. Sealing the container after evacuation can reduce internal gas pressure that might otherwise oppose densification during HIP.

In act 110, the cladding and the fuel substantially simultaneously undergo a hot isostatic pressing process to densify the cladding and the fuel to a desired final density. Act 110 may be performed with the cladding in the container or, when act 108 is omitted, without the container. In some embodiments, the final desired density of the cladding may be a density of about 80% or more of the theoretical maximum density of the material of the cladding. In some embodiments, the final desired density of the cladding may be a density of about 95% or more of the theoretical maximum density of the material of the cladding. In some embodiments, a final desired density of the nuclear fuel may be a density of about 70% or more of the theoretical maximum density of the material of the nuclear fuel.

The HIP process may be conducted at a pressure (e.g., operating pressure) selected based on the equipment capability and the densification goals. In some embodiments, the pressure during the HIP process may be up to about 30,000 psi. A temperature (e.g., operating temperature) of the HIP process may be selected based on the cladding material, the fuel material, and, if used, the support material. In some embodiments, the temperature during the HIP process is selected to densify the cladding to the desired final density and to densify the fuel (fully or partially, depending on the fuel form), while limiting undesired densification of the support material, if present. For example, in some embodiments, the HIP temperature is limited to reduce a tendency of the support material to sinter, agglomerate, and/or form a consolidated mass that is difficult to remove from the cladding. The HIP process may be conducted for an amount of time selected to achieve the desired densification while maintaining the desired geometry.

Because the cladding and the fuel are densified substantially simultaneously, bending or warping of the cladding is reduced or prevented during the hot isostatic pressing process. Furthermore, as a result of the hot isostatic pressing process, the nuclear fuel is densified to a higher density as compared to the initial density of the packed powder. The nuclear fuel may thus more efficiently transmit heat to the cladding at the higher density. By tailoring the density of the nuclear fuel and the density of the cladding during the methods according to embodiments of the disclosure, the desired density of the article may be achieved without causing swelling or other damage since the cladding and the nuclear fuel may consolidate at substantially the same rate during the HIP process. This preserves the shape of the overall article, allowing for more complicated geometries and material pairings than using either additive manufacturing or HIP alone. The resulting article may be substantially fully densified and exhibit no or substantially reduced non-uniformity and shrinkage after act 110.

In act 112, an article including the cladding and nuclear fuel (e.g., a nuclear fuel assembly) is removed from the hot isostatic pressing equipment. If a hot isostatic container was used in act 108, act 112 further comprises removing the cladding and nuclear fuel from the hot isostatic container and removing the support material (or filler material) that was placed within and/or around the cladding before the HIP process. The support material may be removed by mechanical techniques and/or by chemical techniques, depending on the support material selected and the geometry of the cladding. Mechanical removal techniques may include, for example, agitation, vibration, ultrasonic agitation, brushing, probing, and/or fluid flushing to dislodge and remove particulate support material from coolant passageways and other internal regions of the article. In some embodiments, the support material is removed by chemical dissolution and/or electrochemical dissolution, such as by contacting the article (e.g., the support material within the article) with a liquid reagent and optionally circulating the reagent through one or more passageways until the support material is sufficiently removed.

If support material is used, removal of the support material may be combined with a manufacturing-integrated hermeticity check for the cladding. For example, the support material and a dissolution chemistry may be selected such that the dissolution chemistry is formulated to (i) dissolve the support material and (ii) is capable of dissolving the nuclear fuel, but (iii) does not substantially dissolve (or does not materially degrade) the cladding material. After hot isostatic pressing, the article may be placed into a chemical bath containing the dissolution chemistry (and/or the dissolution chemistry may be circulated through the article) to dissolve the support material and expose the exterior of the cladding. If the cladding is hermetically sealed, the dissolution chemistry is prevented from reaching the nuclear fuel. If the cladding includes a crack, leak, or defect, the dissolution chemistry may reach the nuclear fuel and dissolve a detectable amount thereof. In such embodiments, the contents of the chemical bath may be monitored before, during, and/or after support material removal for dissolved fuel species (e.g., uranium for uranium-bearing fuels), such as by inline sampling and analysis and/or spectroscopic monitoring. Cladding hermeticity may, therefore, be evaluated without adding a separate inspection act to the manufacturing process.

After removal of the support material, if present, the article may be rinsed and/or dried prior to further processing.

In act 114, a coating may optionally be applied to one or more surfaces of the article (e.g., exterior surfaces and/or surfaces defining coolant passageways of the nuclear fuel assembly) for one or more purposes. The coating may improve a surface finish and thereby reduce hydraulic losses associated with coolant flow. The coating provided may also enhance corrosion resistance, such as by acting primarily as a chemical barrier rather than as a structural component. The coating may also be selected for cosmetic or identification purposes.

In some embodiments, the coating comprises a metallic coating and/or a ceramic coating. In one non-limiting example, the coating comprises chromium (e.g., metallic chromium) applied to a zirconium alloy cladding. In another non-limiting example, the coating comprises a nickel-based alloy coating, such as for use in environments having relatively aggressive coolants (e.g., molten-salt-cooled environments). In some embodiments, the coating comprises a ceramic coating such as titanium nitride.

In some embodiments, the cladding comprises internal features and/or coolant passageways in which line-of-sight access to interior regions is obscured. Accordingly, some line-of-sight coating techniques (e.g., spray-based coating and/or sputtering from a directional source) may be unsuitable for coating at least some interior surfaces. In such embodiments, the coating may be applied to the article using a non-line-of-sight technique, such as an electroplating, a chemical vapor deposition (CVD) and/or a chemical vapor infiltration (CVI) style approach.

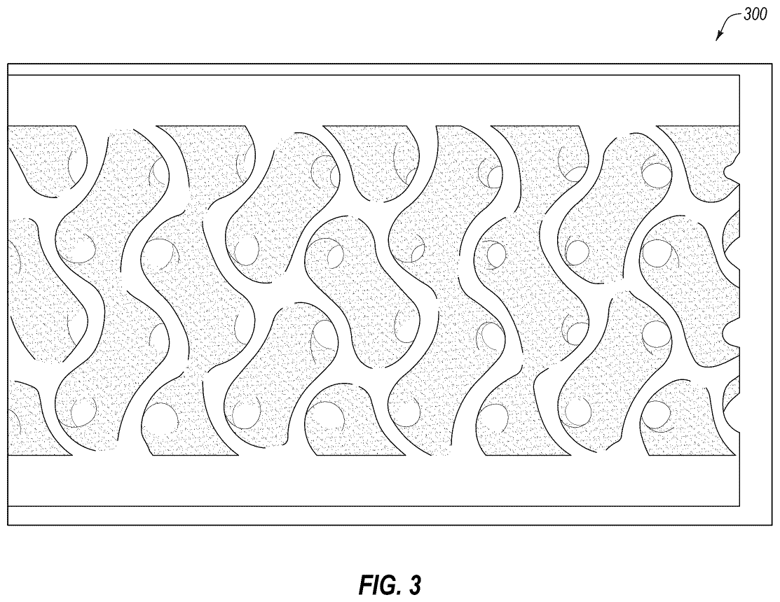

The resulting article (nuclear fuel assembly 200) may exhibit a complex geometry, as shown in FIG. 2. By incorporating the nuclear fuel 204 into the cladding 202 according to embodiments of the disclosure, particles of the nuclear fuel 204 are contained within the cladding 202, which reduces cross contamination.

While the above embodiments have been described with respect to nuclear fuel and cladding for use in a nuclear fuel assembly, the method according to embodiments of the disclosure may be applied to form other dual material articles. For example, instead of a cladding for a nuclear fuel assembly, any other desired part may be formed of a first material and may include an interior volume. Similarly, instead of nuclear fuel, any additional second material may fill the interior volume of the part. That is, the method may be used to form any dual material article where a first material is formed into a part having an interior volume, such as into a complex geometry via additive manufacturing, where a second material is introduced within the interior volume of the part, and where the first and second material are then substantially simultaneously densified via, for instance, a hot isostatic pressing process. The first material and the second material may initially be in a powder form.

In some implementations, the first material and the second material may have the same nominal chemical composition while being provided in different forms. For example, the first material may be an additively manufactured shell or cladding formed of a metal or alloy (e.g., a zirconium alloy or an aluminum alloy), and the second material may be a powder of the same metal or alloy introduced into the interior volume and densified with the shell or cladding during hot isostatic pressing. Alternatively, the first material and the second material may have different chemical compositions, such as different metals, alloys, ceramics, or combinations thereof, depending on a desired functional property of the finished article.

FIG. 2 shows a three-dimensional section of a nuclear fuel assembly 200 fabricated in accordance with embodiments described herein (e.g., fabricated according to the method 100 of FIG. 1) for use in a reactor core. The nuclear fuel assembly 200 may include cladding 202 that forms one or more volumes in which a nuclear fuel 204 may be contained. Surfaces of the cladding 202, which has a complex geometry, define the one or more volumes (e.g., passageways) in which the nuclear fuel 204 is contained. As described above, the cladding 202 exhibits a complex geometry, such as with a TPM surface.

FIG. 3 shows a three-dimensional section of a lattice cladding 300 for a nuclear fuel assembly fabricated in accordance with embodiments described herein. For example, the lattice cladding 300 may be formed utilizing the method 100 described above and may be configured as cladding that is formed by additive manufacturing at a density below a maximum theoretical density of the material forming the lattice cladding. Once the nuclear fuel is added into the cladding, the cladding and the nuclear fuel may simultaneously be densified as explained above.

Fabrication of an article utilizing the above-described methods may provide several advantages. For example, the above-described methods may utilize generally available powder feedstock of any desired material, and any suitable additive manufacturing process may be used. Since hot isostatic pressing processes are well-understood, articles that are formed with the additive manufacturing and hot isostatic pressing processes may be certified by preexisting certification procedures for articles used in nuclear reactors. The above-described methods may also reduce material waste for the cladding and eliminate waste for nuclear fuel as compared to other methods. The methods also reduce radiological and industrial health hazards. The above-described methods reduce the likelihood of contamination between the cladding and the fuel of a nuclear fuel assembly. The methods may be completed at relatively low costs including relatively low capital costs. The method may also facilitate use of ceramic-metal, metal-metal, or ceramic-ceramic fuel systems.

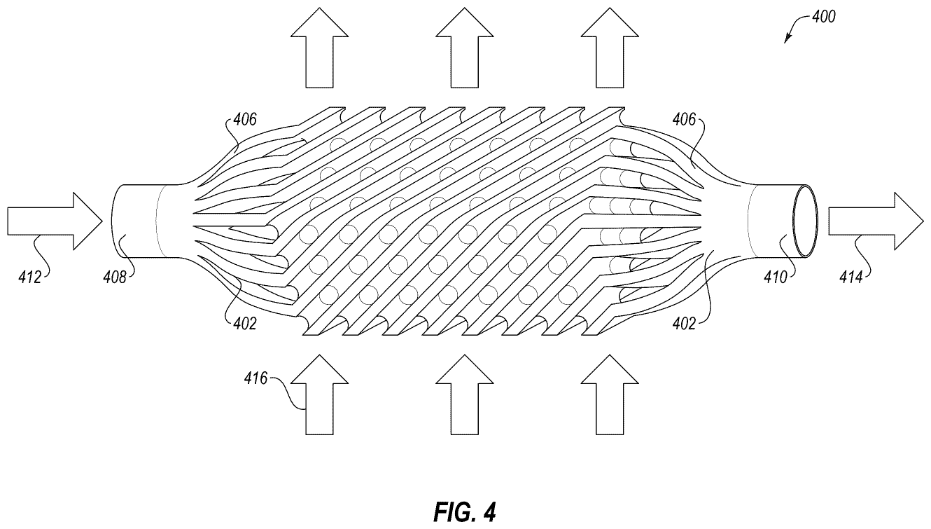

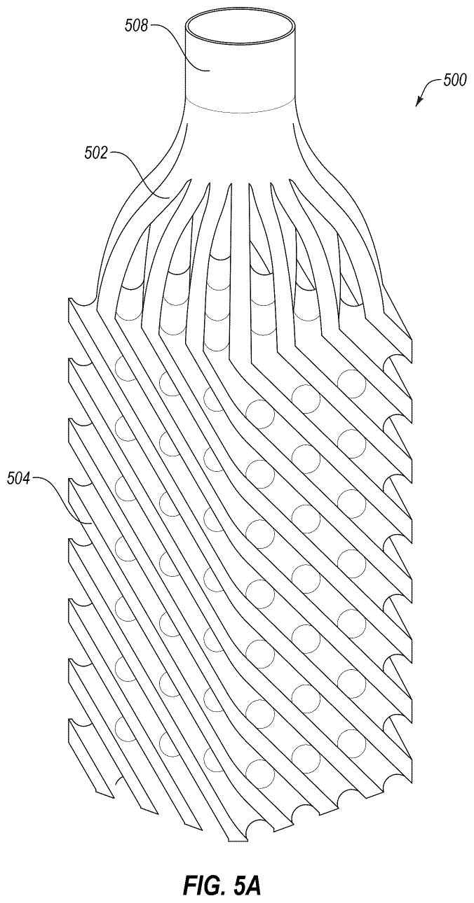

FIG. 4 shows an exemplary nuclear fuel assembly 400 having a lattice cladding 404 with an inlet manifold and an outlet manifold in accordance with some embodiments. The nuclear fuel assembly 400 may be fabricated according to embodiments disclosed herein. For example, the nuclear fuel assembly 400 may be assembled according to the method 100 described above with reference to FIG. 1. As shown in FIG. 4, the nuclear fuel assembly 400 may include a manifold 402 (e.g., a transition manifold) that is provided to facilitate loading and/or unloading of nuclear fuel to/from the lattice cladding 404. For example, act 102 may further comprise additively manufacturing a manifold 402 on one or both ends of the lattice cladding 404 of the nuclear fuel assembly 400. In the example shown in FIG. 4, the manifold 402 is provided on both ends of the lattice cladding 404 forming the nuclear fuel assembly 400, though the manifold 402 may be provided at only one end in some embodiments. The manifold(s) 402 may be formed during a single additive manufacturing process along with the lattice cladding 404. In some embodiments, the manifold(s) 402 may be formed separately from the lattice cladding 404 and may be bonded thereto, such as via a welding or a sintering process.

In some embodiments, the manifold 402 comprises a transition structure configured to interface between (i) a relatively simple port geometry (e.g., a single tubular inlet and/or outlet) and (ii) a plurality of openings at a boundary of the lattice cladding 404. For example, the manifold 402 may include a plurality of branching passageways 406 that divide from a single inlet/outlet 408/410 into multiple branches that are in fluid communication with corresponding openings of the lattice cladding 404. In some embodiments, the branching passageways 406 are configured to change cross-sectional shape along a flow direction. For example, a generally circular cross-sectional shape of the inlet/outlet 408/410 may transition to a set of non-circular passageway cross-sections that correspond to boundary openings created by the lattice geometry, including rectangular, slot-like, polygonal, and/or other cross-sectional shapes.

The number, distribution, and cross-sectional shapes of interface openings between the manifold 402 and the lattice cladding 404 may depend on how the lattice cladding 404 is terminated and/or truncated. For example, lattices defined by repeating unit cells may be truncated by a selected cut plane and/or boundary surface to form a finite fuel assembly. The truncation may create multiple boundary openings and/or non-uniform opening shapes at an end of the lattice cladding 404. In such embodiments, the manifold 402 is configured as a transition manifold to provide an interface for plumbing and/or fuel loading, while still accommodating the boundary opening geometry produced by the selected truncation.

The manifold may facilitate the loading of the nuclear fuel into the cladding in act 106. For example, the fuel may be loaded through an inlet 408 as indicated by arrow 412. The fuel is directed by the manifold 402 into passages within the lattice cladding 404. With a second manifold 402, an outlet 410 may be provided that allows for nuclear fuel to flow through the lattice cladding 404 and out of the nuclear fuel assembly 400 as shown by the arrow 414.

In some embodiments, the manifold 402 (e.g., a transition manifold) is provided as a temporary fuel-loading aid. For example, the manifold 402 may be used to facilitate introduction of the nuclear fuel into the lattice cladding 404 during act 106 (FIG. 1) and may thereafter be removed prior to further processing (e.g., prior to hot isostatic pressing) and/or prior to installation in a reactor. The manifold 402 may be removed by, for example, cutting, machining, and/or otherwise separating the manifold 402 from an end region of the lattice cladding 404, thereby leaving a truncated end of the lattice cladding 404 for subsequent densification. In another non-limiting embodiment, after removing the manifold 402, the exposed end region may be closed (e.g., welded shut), such as by applying a weld closure to seal the boundary openings.

In such embodiments, after removal of the manifold 402, the exposed end region of the lattice cladding 404 may be sealed to form a desired boundary. In one non-limiting embodiment, a cap layer (not shown) comprising particles (e.g., a powder) may be placed over the exposed end region (e.g., over a fuel layer and/or over boundary openings of the lattice). During subsequent densification (e.g., during HIP), the cap layer may consolidate to seal the boundary and form a hermetic closure.

In some embodiments, the fuel-loading operation uses a fluidization-assisted approach. For example, during act 106, a gas may be introduced through a first manifold (e.g., the outlet-side manifold 402) to flow through at least a portion of the lattice cladding 404 while particulate fuel is introduced through a second manifold (e.g., the inlet-side manifold 402). The gas flow may at least partially fluidize the particulate fuel and/or reduce bridging during loading, thereby promoting more uniform distribution within the lattice cladding 404. In such embodiments, providing manifolds 402 on both ends of the lattice cladding 404 facilitates establishing a flow path for the gas while maintaining a separate port for particulate introduction and/or venting.

During use and operation of a nuclear reactor including the nuclear fuel assembly 400, coolant may flow through the lattice cladding 404 in passageways that are kept separate from fuel via the lattice cladding 404 as indicated by the arrows 416.

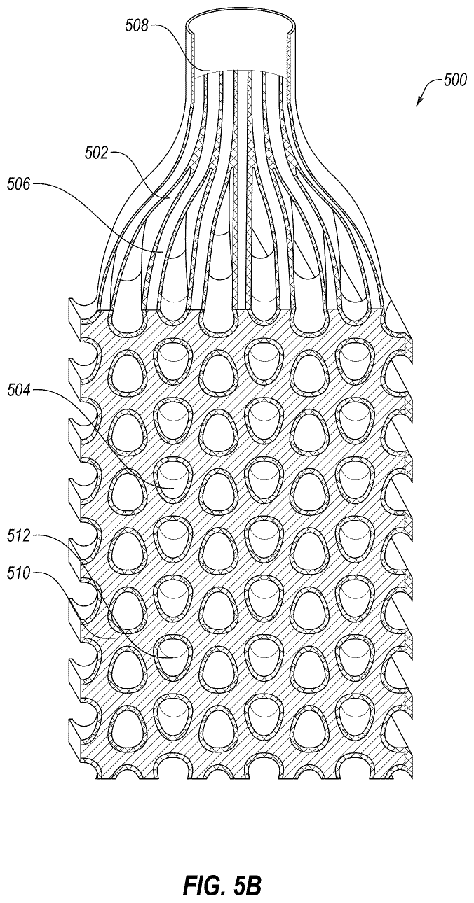

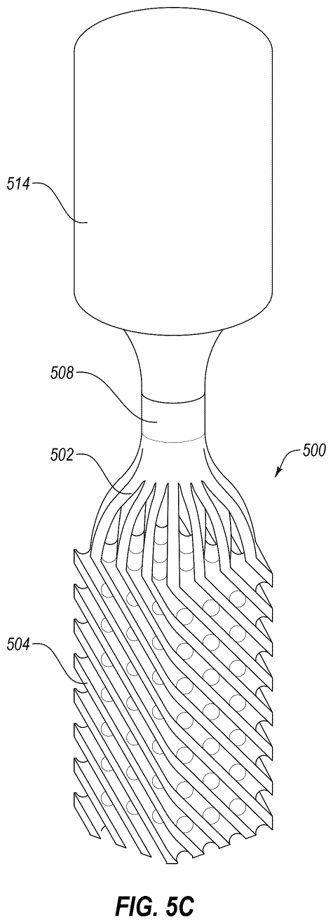

FIG. 5A shows an exemplary lattice cladding of a nuclear fuel assembly 500 with an attached manifold 502, and FIG. 5B shows a section view of the nuclear fuel assembly 500 with the attached manifold 502 of FIG. 5A in accordance with some embodiments. FIG. 5A and FIG. 5B show a nuclear fuel assembly 500 similar to nuclear fuel assembly 400. The nuclear fuel assembly 500 comprises a manifold 502 attached to a lattice cladding 504. The manifold 502 comprises a plurality of manifold passageways 506 that branch out from an inlet/outlet 508 and lead to an interior volume of the lattice cladding 504. As shown in FIG. 5B, nuclear fuel 510 may be introduced into the interior volume of the lattice cladding 504 via the manifold 502. During use and operation of a nuclear reactor including the nuclear fuel assembly 500, the lattice cladding 504 maintains the nuclear fuel separately from, and promotes heat transfer to, coolant that flows through the coolant passageways 512. As mentioned above, the manifold 502 may facilitate loading of the nuclear fuel and then may be removed prior to HIP processing or may remain as part of the nuclear fuel assembly 500, such as to facilitate diffusion of fission gases.

For example, as shown in FIG. 5C, the manifold 502 may be retained as part of the nuclear fuel assembly 500 and is configured to provide, or to interface with, a free volume for management of fission gas. For example, a fission gas reservoir 514 may be located above a fuel-containing region (e.g., within the lattice cladding 504) and may be fluidly coupled to the nuclear fuel assembly 500 via the manifold 502. In some embodiments, the fission gas reservoir 514 includes an enclosed volume (e.g., a pressure-vessel volume) attached to the manifold 502. The fission gas reservoir 514 may be attached after densification, such as by welding a reservoir component to the manifold 502 after hot isostatic pressing, thereby providing additional free volume for fission gases without the reservoir being present during HIP processing.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A method for fabricating an article comprising different materials, the method comprising:
forming a part from a first material via additive manufacturing, the part exhibiting a first density and surfaces of the part defining an interior volume;
introducing a second material into the interior volume of the part, the second material exhibiting a second density; and
processing the part comprising the first material and the second material via hot isostatic pressing to form the article, the first material of the part exhibiting a third density that is greater than the first density and the second material within the part exhibiting a fourth density that is greater than the second density.

2. The method of claim 1, wherein forming the part comprising forming the part to exhibit a complex geometry comprising a triply periodic minimal surface (TPMS) lattice periodically repeated in three dimensions.

3. The method of claim 1, wherein the first material and the second material have the same chemical composition.

4. The method of claim 1, wherein forming the article comprises densifying the first material to exhibit the first density greater than or equal to about 50% and less than or equal to about 90% of a theoretical maximum density of the first material.

5. The method of claim 1, further comprising, prior to processing via hot isostatic pressing, removing at least a portion of a polymeric binder from the part.

6. A method of fabricating a nuclear fuel assembly, the method comprising:
forming a cladding via additive manufacturing, the cladding exhibiting a first density that is less than a theoretical maximum density of a material of the cladding, the cladding defining an interior volume;
introducing a nuclear fuel into the interior volume of the cladding; and
densifying the cladding and the nuclear fuel in the interior volume via hot isostatic pressing, the cladding exhibiting a second density that is greater than the first density.

7. The method of claim 6, wherein forming the cladding exhibiting the first density comprises forming the cladding at a density greater than or equal to about 50% of the theoretical maximum density of the material of the cladding.

8. The method of claim 6, wherein forming the cladding exhibiting the first density comprises forming the cladding at a density corresponding to a density of the nuclear fuel prior to the densifying.

9. The method of claim 6, further comprising, after forming the cladding and prior to introducing the nuclear fuel, debinding the cladding to remove at least a portion of a polymeric binder.

10. The method of claim 9, wherein debinding the cladding comprising sintering the cladding to a predetermined density that is greater than the first density and less than the second density after hot isostatic pressing.

11. The method of claim 6, wherein introducing the nuclear fuel comprises pouring nuclear fuel particles into the interior volume via a transition manifold attached to the cladding to form a packed powder within the interior volume.

12. The method of claim 11, wherein introducing the nuclear fuel comprises vibration packing the nuclear fuel particles by tapping and/or mechanical vibration of the cladding.

13. The method of claim 11, wherein introducing the nuclear fuel comprises introducing a first batch of the nuclear fuel particles, vibrating the cladding to pack the first batch, and introducing one or more additional batches of the nuclear fuel particles with intervening vibration.

14. The method of claim 11, wherein introducing the nuclear fuel comprises flowing an inert gas through the cladding during introduction of the nuclear fuel particles.

15. The method of claim 6, wherein the nuclear fuel has a packed density of from about 40% to about 75% of a theoretical maximum density of the nuclear fuel prior to densifying the cladding.

16. The method of claim 6, further comprising, after densifying the cladding via hot isostatic pressing, removing a support material surrounding the cladding by at least one of mechanical removal or chemical dissolution and checking hermeticity of the nuclear fuel assembly by monitoring the removed support material for nuclear fuel species.

17. A nuclear fuel assembly comprising:
a lattice cladding formed of a cladding material, the lattice cladding defining a nuclear fuel-receiving interior volume and coolant passageways separated from the nuclear fuel-receiving interior volume by walls of the lattice cladding;
nuclear fuel disposed within the nuclear fuel-receiving interior volume; and
a transition manifold coupled to an end region of the lattice cladding, the transition manifold comprising a port and branching passageways between the port and openings at a boundary of the lattice cladding,
wherein the lattice cladding comprises a complex geometry defining one or more of tortuous passageways or intertwined internal passageways, and
wherein the lattice cladding exhibits a density of at least about 95% of a theoretical maximum density of the cladding material, and wherein the nuclear fuel exhibits a density of at least about 70% of a theoretical maximum density of the nuclear fuel.

18. The nuclear fuel assembly of claim 17, wherein the complex geometry of the lattice cladding comprises a triply periodic minimal surface (TPMS) lattice defined by an implicit surface equation and periodically repeated in three dimensions.

19. The nuclear fuel assembly of claim 17, wherein the branching passageways are configured to change cross-sectional shape along a flow direction such that the port transitions to non-circular passageway cross-sections corresponding to the openings at the boundary of the lattice cladding.

20. The nuclear fuel assembly of claim 17, further comprising a fission-gas reservoir fluidly coupled to the lattice cladding via the transition manifold.
